(19) United States
(12) Patent Application Publication
(10) Pub. No.: US 2008/0024447 A1
(43) Pub. Date: Jan. 31, 2008

(54) Multidimensional Mouse and Stabilizer Therefor

(75) Inventors: Michael Hsieh, San Jose, CA (US); Taizo Yasutake, Cupertino, CA (US)

Correspondence Address: TECHNOLOGY & INTELLECTUAL PROPERTY;STRATEGIES GROUP PC (dba TIPS GROUP), P. O. BOX 1639, LOS ALTOS, CA, 94023-1639, US

(73) Assignee: Sandio Technology Corp., San Jose, CA (US)

(21) Appl. No.: 11/830,819

(22) Filed: Jul. 30, 2007

Related U.S. Application Data
(60) Provisional application No. 60/834,524, filed on Jul. 31, 2006.

(51) Int. Cl. G06F 3/033

(52) U.S. Cl. 345/163

(57) ABSTRACT

Example embodiments provide a mouse with a stabilizer. In particular embodiments, the stabilizer includes a U-shaped body which attaches to the bottom of the mouse so that the bottom surface of the U-shaped body forms a horizontal plane with the bottom surface of the mouse. In one embodiment, the U-shaped body includes a heel-rest portion and a pair of leg portions, one of which includes a thumb-rest and one of which includes a finger-rest. The leg portions define an opening for an opto-electric sensor such as a laser. In another embodiment, the stabilizer attaches to the rear of the mouse but does not extend forward to provide a thumb-rest or a finger-rest. In some embodiments, the stabilizer is fixedly attached or formed as part of the mouse, whereas in other embodiments it is detachable.

### CROSS-REFERENCE TO RELATED APPLICATIONS

This application claims the benefit of U.S. Provisional Application No. 60/834,524, filed Jul. 31, 2006, incorporated herein by reference.

### BACKGROUND

In computing, a mouse functions as a pointing device by detecting two-dimensional motion relative to the mouse's supporting surface. The mouse's motion translates into the motion of a cursor or other pointer on a visual display device, such as a monitor, that accepts input from a computer.

In practice, numerous mechanisms have been used to detect the two-dimensional motion relative to the supporting surface. For example, a ball mouse utilizes two rollers which roll against two sides of a ball. One roller detects the horizontal motion of the mouse and other roller detects the vertical motion. The motion of these two rollers causes, for example, two disc-like encoder wheels to rotate, which in turn causes interruptions of optical beams to generate electrical signals. The mouse sends these signals to the computer system by connecting wires. The driver software in the computer system then converts the signals into motion of the mouse pointer along X and Y axes on a display screen.

In another example, an optical mouse typically uses a light-emitting diode (LED) and photodiodes to detect movement relative to the underlying surface by examining the light reflected off of it. A laser mouse uses a small inflated laser, which increases the resolution of the reflected image. Inertial mice, by further example, use a tuning fork or other accelerometer to detect movement along an axis.

Physically, a mouse consists of a small case, held under one of the user's hands, with one or more buttons and a wheel. Trough a typical mouse might have two clickable buttons (e.g., a left button for a right-handed user's index finger and right button for such a user's middle or ring finger), mouse designers have also built mice with five or more buttons. Depending on the user's preferences and software environment, the extra buttons might allow more dimensional input or more control. For example, the extra buttons might allow for forward and backward web-navigation or scrolling through a browser's history.

Because software can map mouse-buttons to virtually any keystroke, function, or application, the additional buttons can make working with such a mouse both easier and more efficient. This is especially useful in computer games, where quick and easy access to a wide variety of functions (e.g., weapon-switching in “first person shooter” games) can give a player an advantage. Ordinarily, the wheel allows the user to perform various system-dependent operations.

Mice with ergonomic designs or features have attained considerable popularity. Some of these designs tend to emphasize human health and safety. An example of such a mouse is the mouse with a hand and wrist support block described in U.S. Pat. No. 5,340,067. Purportedly, the support block helps prevent cumulative trauma disorder. U.S. Pat. No. 6,616,108 claims a similar support block, though one which is detachable and deformable, while U.S. Pat. No. Des. 402,280, claims a design for a detachable palm support. However, these designs tend to provide little in the way of stability for the sophisticated and intricate hand and finger movements performed by users involved with gaming or other multidimensional image manipulation. In fact, these designs might actually hinder such movements.

Designs to facilitate such movements do exist, though they tend to involve significant, if not radical, changes to the physical interface of the traditional mouse to which users have become accustomed. Examples of such designs are the input device with side grip described in U.S. Pat. No. 6,828,958 and the mouse-keyboard adjunct for image manipulation described in U.S. Published Patent Application No. 2007/0164995. Of course, such designs provide little in the way of backward compatibility for users of more traditional mice and consequently such designs require users to put considerable time and effort into learning how to use them efficiently.

### SUMMARY

Exemplary embodiments provide apparatuses, systems, and methods directed to a stabilizer for a mouse which mouse has an additional button on the top and each side for multidimensional input.

In one embodiment set forth by way of example and not limitation, a stabilizer includes a U-shaped body which attaches to the bottom of the mouse so that the bottom surface of the U-shaped body forms a horizontal plane with the bottom surface of the mouse body. In this exemplary embodiment, the U-shaped body includes a heel-rest portion and a pair of leg portions, one of which includes a thumb-rest and one of which includes a finger-rest. In another exemplary embodiments, the stabilizer forms a part of and is integral with the mouse body.

Also, in this exemplary embodiments, the leg portions define an opening for an opto-electric sensor such as a laser. In other exemplary embodiments, the mouse's x-y sensor might be a trackball or an accelerometer or some other form of an opto-electric sensor such as an LED.

In some exemplary embodiments, the stabilizer is fixed to the mouse, whereas in other exemplary embodiments it is detachable. In one exemplary embodiment, the U-shaped body of the stabilizer has a tab support extending into the opening for the x-y sensor. In this exemplary embodiment, the tab support has a bottom surface substantially coplanar with the bottom surface of the U-shaped body, but a top surface recessed from the top surface of the U-shaped body. The tab support supports a tab extending upwards which fits into a slot on the bottom surface of the mouse.

In another alternative exemplary embodiment, the stabilizer attaches to the rear of the mouse but does not extend forward to provide a thumb-rest or finger-rest. In this exemplary embodiment, an opening for an x-y sensor is not needed since the stabilizer has truncated legs.

These and other embodiments will become apparent to those of skill in the art upon a reading of the following descriptions and a study of the several figures of the drawings.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 is a perspective view of a mouse with stabilizer, in accordance with an exemplary embodiment.

FIG. 2 is an exploded view of the mouse with stabilizer.

FIG. 3 is a top plan view of the mouse with stabilizer of FIG. 1.

FIG. 4 is a left side elevated view taken along line 4-4 of FIG. 3.

FIG. 5 is an exploded view of the mouse with stabilizer of FIG. 4.

FIG. 6 is a right side elevated view taken along line 6-6 of FIG. 3.

FIG. 7 is a bottom plan view taken along line 7-7 of FIG. 5.

FIG. 8 is a bottom plan view taken along tine 8-8 of FIG. 5.

FIG. 9 is a top plan view taken along line 9-9 of FIG. 5.

FIG. 10 illustrates an exemplary locking attachment for a stabilizer.

FIG. 11 illustrates a tang and a tab in an unlocked position, in accordance with an exemplary embodiment.

FIG. 12 illustrates a tang and a tab in a locked position, in accordance with an exemplary embodiment.

FIG. 13 is a bottom plan view taken along lines 13-13 of FIG. 4.

FIG. 14 is a cross-sectional view taken along line 14-14 of FIG. 3.

FIG. 15 is a perspective view of a user using a mouse with stabilizer, in accordance with an exemplary embodiment.

FIG. 16 is a perspective view of a mouse with stabilizer, in accordance with an exemplary embodiment.

FIG. 17 is an exploded view of the mouse with stabilizer of FIG. 16.

FIG. 18 is a top plan view of the mouse with stabilizer of FIG. 16.

FIG. 19 is a bottom plan view of the mouse with stabilizer of FIG. 16.

FIG. 20 is a cross-sectional view taken along line 20-20 of FIG. 18.

### DETAILED DESCRIPTION

The following embodiments are described and illustrated in conjunction with apparatuses, systems, and methods which are meant to be exemplary and illustrative, not limiting in scope.

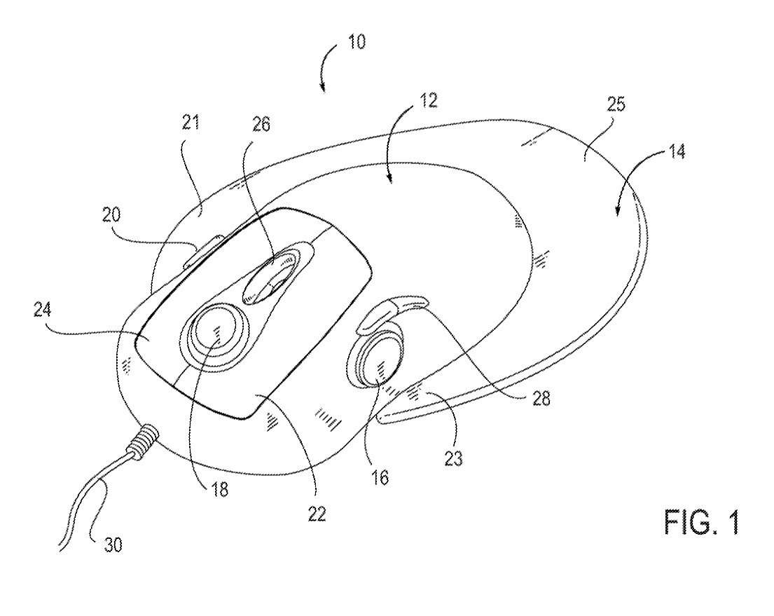

FIG. 1 is a perspective view of a mouse assembly 10 with stabilizer, in accordance with an exemplary embodiment. The mouse assembly 10 includes a mouse 12 portion and a stabilizer 14 portion. The mouse 12, in this exemplary embodiment, can be an embodiment of the multidimensional mouse described in the commonly-owned U.S. Published Patent Application No. 20060250353, filed on Dec. 29, 2005, entitled “Multidimensional Input Device”, incorporated herein by reference. The exemplary mouse 12 includes a left side button 16, a top button 18, and a right side button 20, all of which can be used to provide dimensional input over and above that provided by the mouse's x-y sensor. One leg 21 of the U-shaped stabilizer 14 extends substantially to button 20 on the right side, providing a rest for the user's little finger, and the other leg 23 of the stabilizer extends substantially to button 16 on the left side of the mouse 12, providing a rest for the user's thumb. The base 25 of the stabilizer 14 which connects legs 21 and 23 provides a rest for the heel of a user's hand.

The mouse 12 also includes five other input mechanisms: (a) a left top button 22; (b) a right top button 24; (c) a scroll wheel 26; and (d) two programmable buttons 28 above the left side button 16. Finally, the exemplary mouse 12 connects to a computer via a cable 30. In other embodiments, the mouse 12 is a wireless mouse.

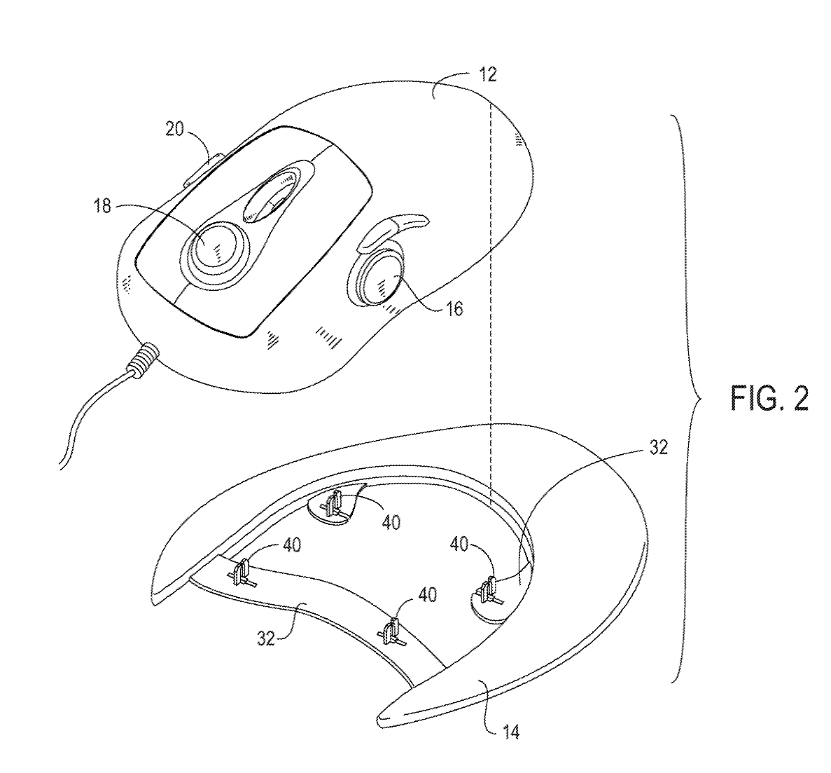

FIG. 2 illustrates an exploded view of a mouse 12 and a stabilizer 14, in accordance with an exemplary embodiment. The mouse 12 is elevated above where it would fit into the stabilizer 14. The figure illustrates three tab supports, each of which is labeled 32, that are coplanar with the bottom surface of stabilizer 14. As shown in the figure, each tab support 32 supports a tab 40 whose function will be described in further detail below.

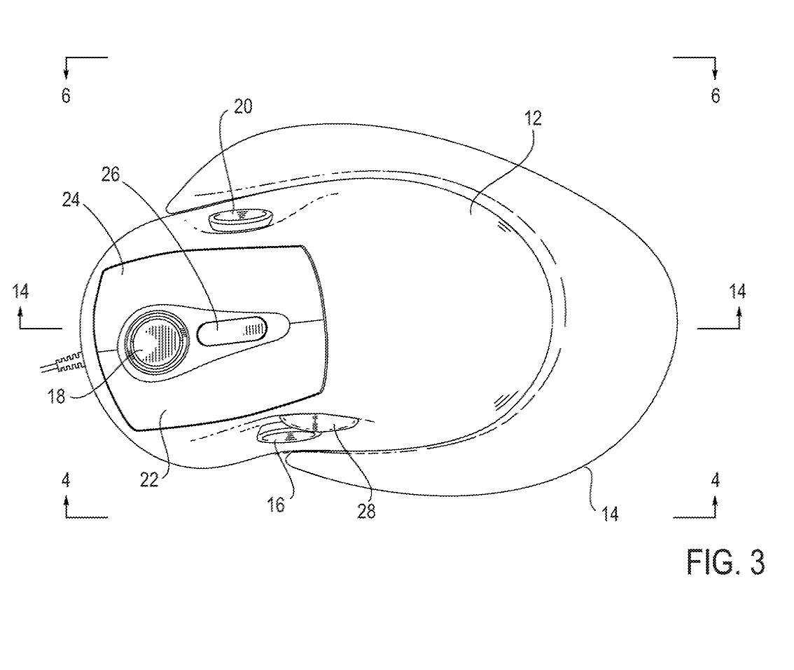

FIG. 3 is a top plan view of the mouse assembly 10. Shown in FIG. 3 are the three buttons which might be used to provide dimensional input over and above that provided by the mouse's x-y sensor, in some exemplary embodiments: (a) the left side button 16; (b) the top button 18; and (c) the right side button 20. The efficient use of these buttons, alone or in combination, might require the user to perform sophisticated or intricate hand and finger movements which benefit from the stability provided by stabilizer 14. Likewise the stabilizer 14 provides additional stability when a user uses these dimensional-input buttons in combination with the input mechanisms that are found on mice which are not multidimensional, e.g., the left top button 22, the right top button 24, the scroll wheel 26, and the programmable buttons 28.

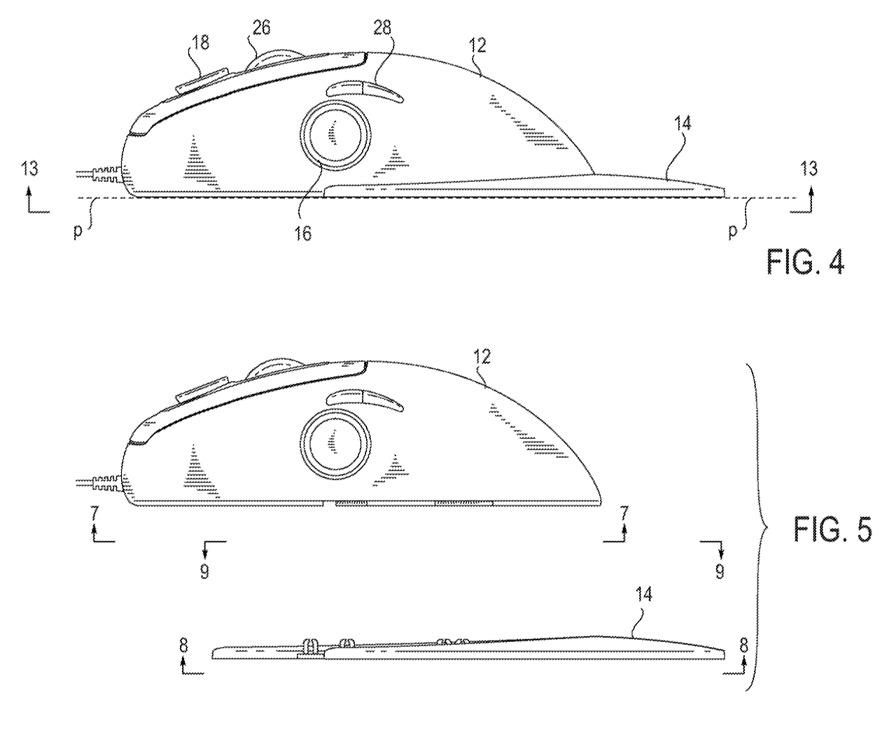

FIG. 4 is a left side elevational view of the exemplary assembly 10. For ease of comprehension, the figure also illustrates the left side button 16, the top button 18, the scroll wheel 26, and the two programmable buttons 28. As shown in the figure, when the stabilize 14 is attached to the mouse 12, their two bottom surfaces ate substantially coplanar along a plane p-p and therefore will not impede movement of the mouse assembly 10 in an x-y direction across a horizontal surface such as a mouse pad or desktop. It will be appreciated that such substantial co-planarity additionally has the benefit that the mouse's x-y sensor will be properly aligned and function properly regardless of whether the stabilizer 14 is attached. When the stabilizer 14 is attached to the mouse 12, the mouse's x-y sensor is not occluded by the stabilizer 14. Not shown in this figure are the Teflon mouse feet that may optionally be attached to the bottom surfaces of the mouse 12 and the stabilizer 14, in some exemplary embodiments. The Teflon mouse feet are thin and do not affect the essential co-planarity of the bottom surfaces.

FIG. 5 is an exploded view of FIG. 4. As will be described in further detail below, the stabilizer 14 attaches to the bottom surface of the mouse 12, in some exemplary embodiments.

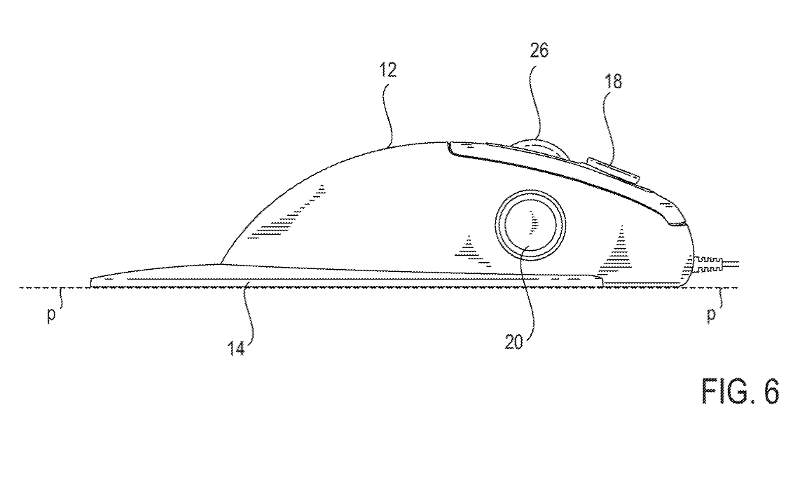

FIG. 6 is a right side elevational view of exemplary mouse assembly 10. The button surfaces of right side button 20 can be well seen in this figure. The stabilizer 14 and mouse 12 are again shown to be essentially coplanar along the plane p-p.

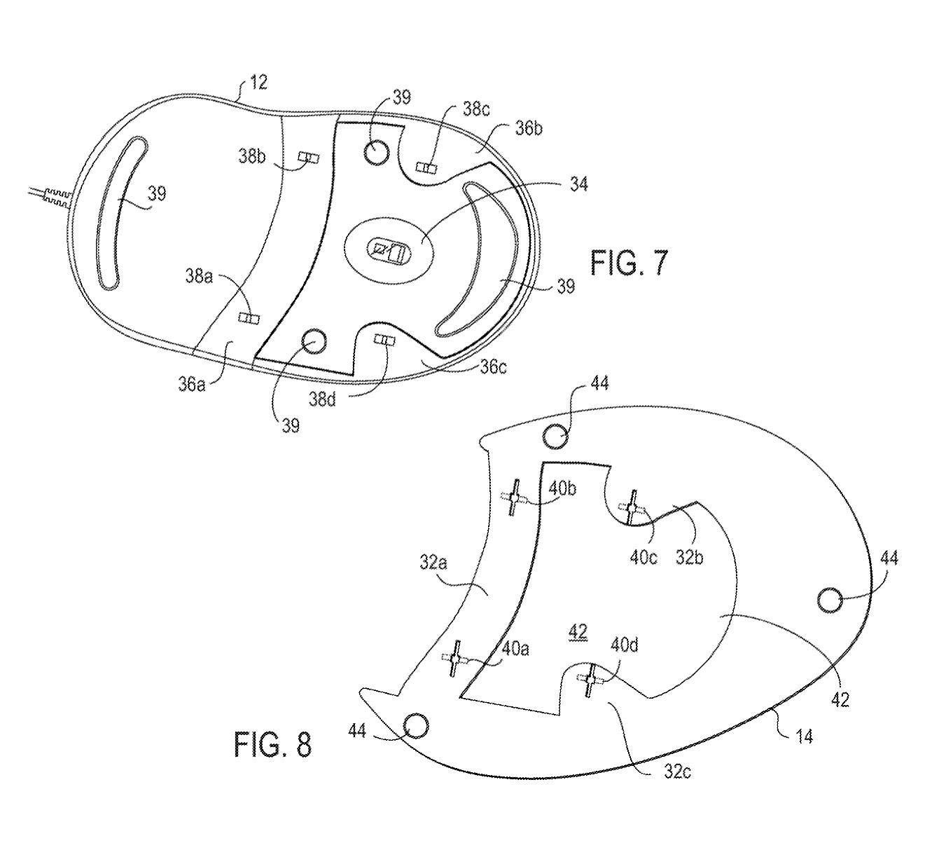

FIG. 7 is a bottom plan view of mouse 12 without the stabilizer 14. It will be appreciated that this view corresponds to the exploded view shown in FIG. 5, insofar as the mouse 12 is detached from the stabilizer 14. FIG. 7 illustrates an opto-electric sensor 34 that is carried by the mouse 12. In some exemplary embodiments, this sensor might be an LED or a laser. In an alternative embodiment, the sensor might comprise a trackball.

FIG. 7 also illustrates three recesses 36 in the bottom surface of the mouse 12, labeled 36a, 36b, and 36c. These three recesses correspond to the three tab supports 2 illustrated in FIG. 2 and facilitate the co-planarity of the bottom surface of mouse 12 with the bottom surface of stabilizer 14. FIG. 7 also illustrates four slots 38, labeled 38a, 38b, and 38c. When the mouse 12 is attached to the stabilizer 14, the stabilizer's tabs fit into these slots, as described in further detail below. Teflon mouse feet 39 help the mouse 12 to slide along a tracking surface. Also depicted in this figure is the mouse's optic-electric sensor 34.

FIG. 8 is a bottom plan view stabilizer 14. It will be appreciated that this view also corresponds to the exploded view shown in FIG. 5, insofar as the mouse 12 is detached from the stabilizer 14. For didactic purposes, the figure shows the bottoms of four tabs 40, labeled 40a, 40b, 40c, and 40d, which tabs extend perpendicularly into the page. Tabs 40a and 40b are supported by tab support 32a tab 40c is supported by tab support 32b, and tab 40d is supported by tab support 32c. As shown in FIG. 8, the tab supports define an opening 42 for the opto-electric sensor 34 illustrated in FIG. 7. Finally, FIG. 8 illustrates three Teflon mouse feet, each of which is labeled 44, that facilitate x-y movement of the mouse-stabilizer 10 on a horizontal surface such as a mouse pad or desktop.

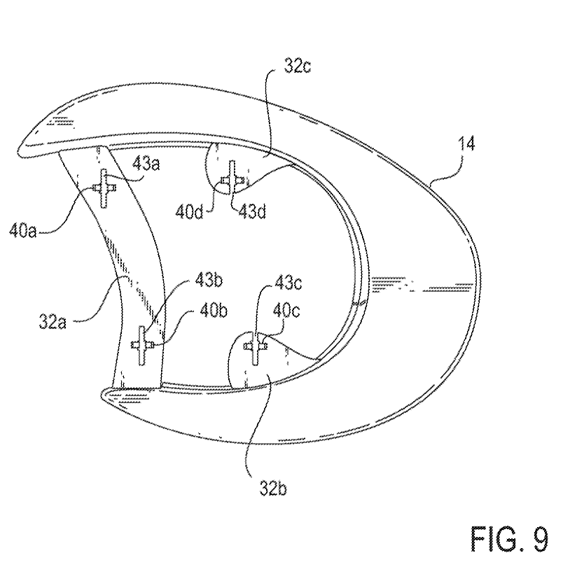

FIG. 9 is a top plan view of a stabilizer 14. Again, it will be appreciated that this view also corresponds to the exploded view shown in FIG. 5, insofar as the mouse 12 is detached from the stabilizer 14. The figure illustrates the three tab supports 32a, 32b, and 32c. Attached to or forming a part of the tab supports 32 are tabs labeled 40a, 40b, 40c, and 40d, which have slits labeled 43a, 43b, 43c and 43d, respectively. As previously noted, the upper surfaces of tab supports 32 are recessed from the upper surface of the stabilizer 14, so as to fit in corresponding recesses 36a, 36b, and 36c on the bottom surface of the mouse 12. It will be appreciated that the top surface of the stabilizer 14 is curved, which makes it comfortable for resting the user's thumb, little finger, and hand, and that such resting provides additional stability for the sophisticated and intricate mouse movements involved in the multidimensional manipulation of images.

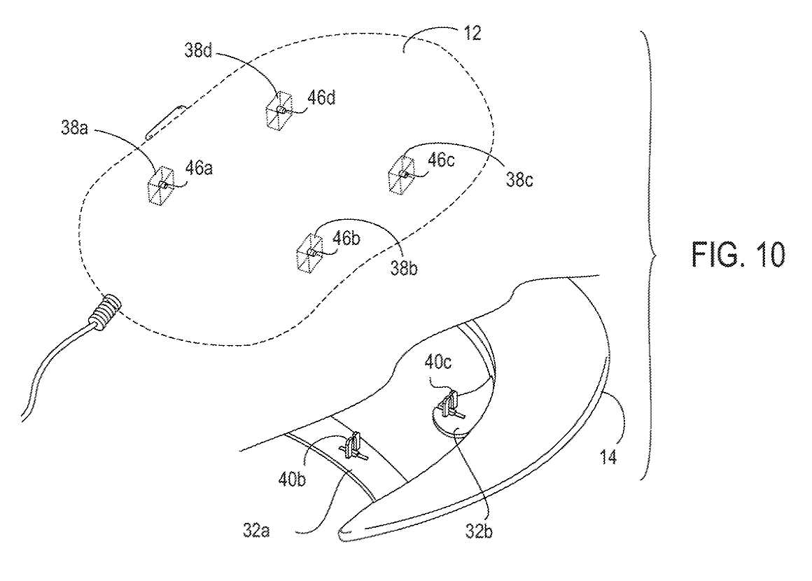

FIG. 10 illustrates a locking attachments for a stabilizer 14, which locking attachment comprises slots 38, tabs 40, and tangs 46, in accordance with an exemplary embodiment. The top of the figure shows in phantom a mouse 12 on whose bottom surface are four rectangular slots 38a, 38b, 38c, and 38d. Within each slot is a tang 46, labeled 46a, 46b, 46c, and 46d respectively. The tabs 40, which are slotted, are essentially perpendicular to the tab supports 32 in this exemplary embodiment.

FIG. 11 illustrates a slot 38 and a tab 40 in an unlocked position, in accordance with an exemplary embodiment. As illustrated in the figure, a slot 38 is provided with a tang 46, which is adapted to engage with a tab 40. As can be seen, each of the tabs 40 have a slit 43 in the tab support 32 which slit allows the tab to flex laterally without snapping as indicated by the arrows marked “f”, if engaged to tang 46 and thereby trap the tab within enclosure 41.

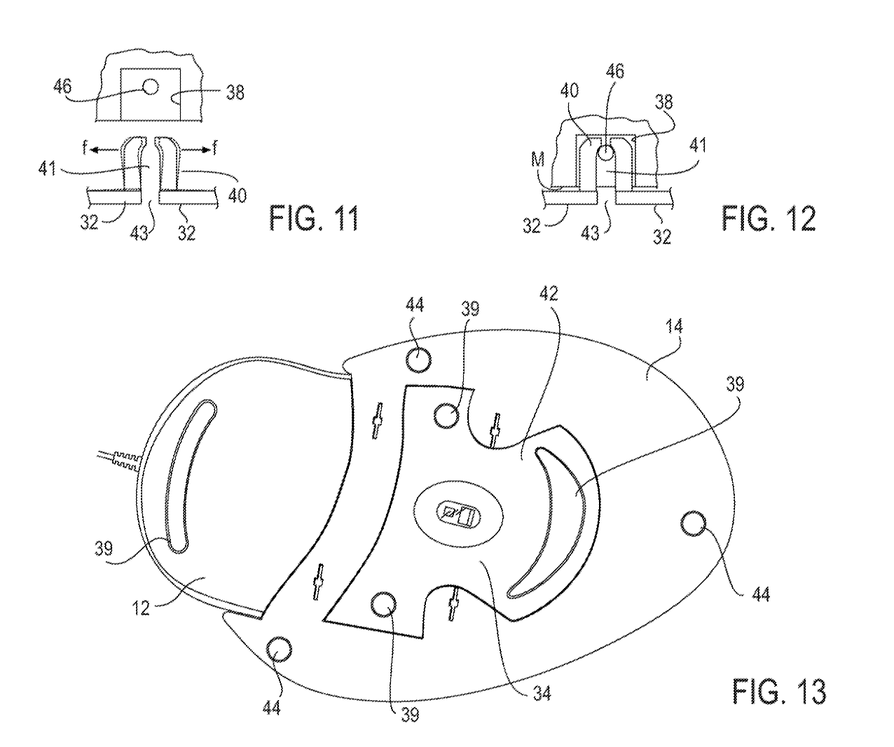

FIG. 12 illustrates a slot 38 and a tab 40 in a locked position, in accordance with an exemplary embodiment. As illustrated in the figure, the tab 40 locks onto the tang 46, securing the tab support 32 against the mouth M of the slot 38. Also shown in the figure is the slit 43 in the tab support 32 and the enclosure 41. It will be appreciated that when the tabs 40 on the stabilizer's tab supports 32 are locked into the slots 38 on the mouse's bottom surface, the stabilizer's bottom surface is substantially coplanar with the mouse's bottom surface so as to allow the mouse assembly 10 to move unimpeded in an x-y direction across a horizontal surface such as a mouse pad or desktop with proper tracking.

FIG. 13 is a bottom plan view of the mouse assembly 10. The figure again illustrates an opening 42 in the stabilizer 14 for the opto-electric (or other) sensor 34 carried by the mouse 12. Additionally, the figure depicts numerous Teflon mouse feet 39 and 44 in various shapes such as circles and elongated semi-circles, which again, preferably have coplanar lower surfaces. Though the figure depicts mouse feet 39 and 44 made of Teflon, other exemplary embodiments can use other materials with a low coefficient of friction for the mouse feet 39 and 44.

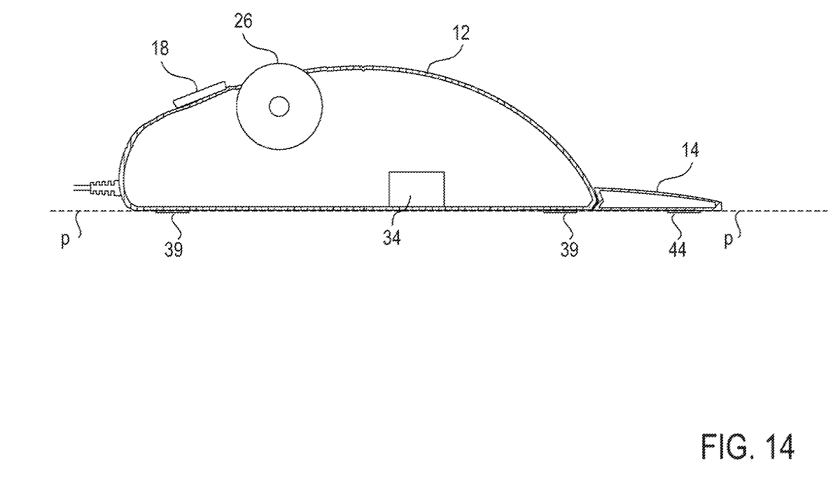

FIG. 14 is a simplified cross-sectional view of a mouse assembly 10, in accordance with this exemplary embodiment. For ease of comprehension, the figure illustrates the top button 18 and the scroll wheel 26 depicted in FIG. 3, as well as the opto-electric sensor 34. Also illustrated in FIG. 14 are Teflon mouse feet 39 and 44. The figure further illustrates how the mouse 12 and the stabilizer 14 are coplanar plane p-p, when the stabilizer 14 is attached to the mouse 12.

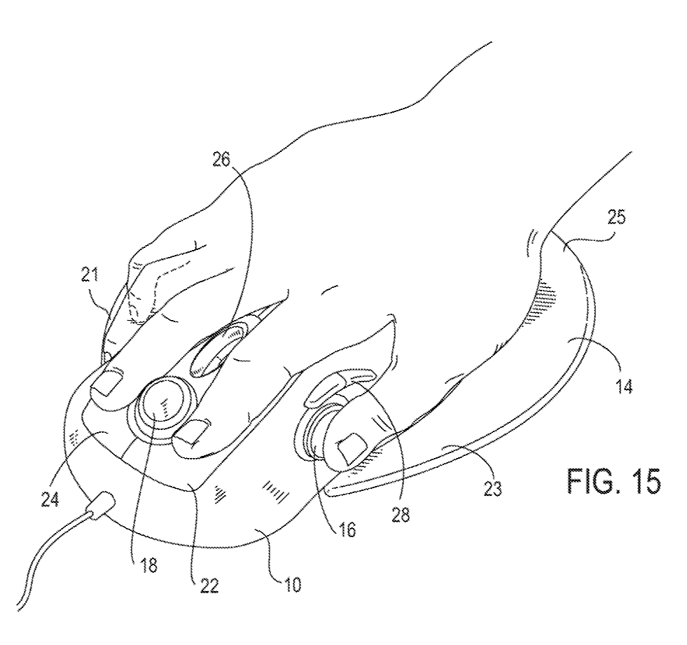

FIG. 15 is a perspective view of a user's hand with a mouse assembly 10. As illustrated in the figure, the user has his index finger on the left top button 22 and his middle finger on the right top button 24. In between those two fingers are the scroll wheel 26 and the top button 18, which button is for dimensional input. The user has her thumb on the left button 20, which button is also for dimensional input and which is located below the tho programmable buttons 28. As depicted in the figure, the user may be resting his thumb on leg 23 of the stabilizer 14, may be resting his little finger on the other leg 21 of the stabilizer, and may be resting his hand on the base 25 of the stabilizer.

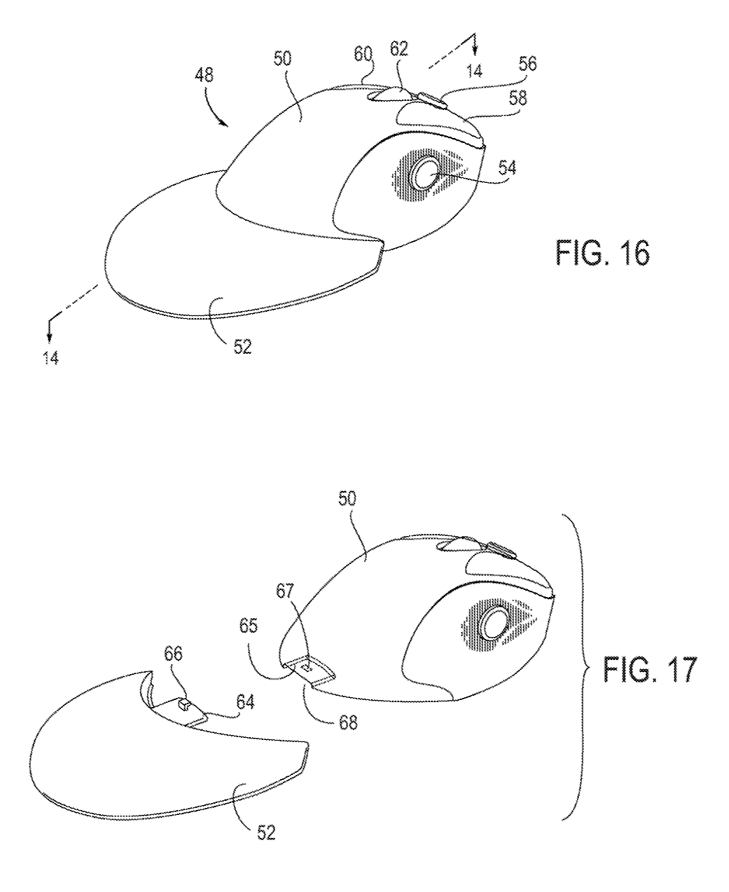

FIG. 16 is a perspective view of a mouse assembly 48, in accordance with an exemplary embodiment. Here again, the mouse 50 portion, in this exemplary embodiment, can be an embodiment of the multidimensional mouse described in the commonly-owned U.S. Published Patent Application No. 20060250353, incorporated by reference. In the figure, the mouse 50 includes a right button 54, a top button 56, and a left button (not shown), all of which might be used to provide dimensional input over and above that provided by the mouse's x-y sensor, in some exemplary embodiments. Also illustrated in the figure are the mouse's right top button 58, left top button 60, and scroll wheel 62. In this exemplary embodiment, the legs of the stabilizer 52 are truncated so that the stabilizer provides a rest for the user's palm but not for the user's thumb or little finger.

FIG. 17 is an exploded perspective view of the mouse assembly of FIG. 16. As illustrated in the figure, the stabilizer's bottom surface includes a tab support 64 for a perpendicular tab 66 both of which fit into a corresponding slot 68 on the bottom surface of the mouse 50. When the stabilizer 52 is attached to the mouse 50, their bottom surfaces preferably are substantially coplanar so as not impede x-y movement of the mouse assembly 48 across a horizontal surface such as a mouse pad or desktop.

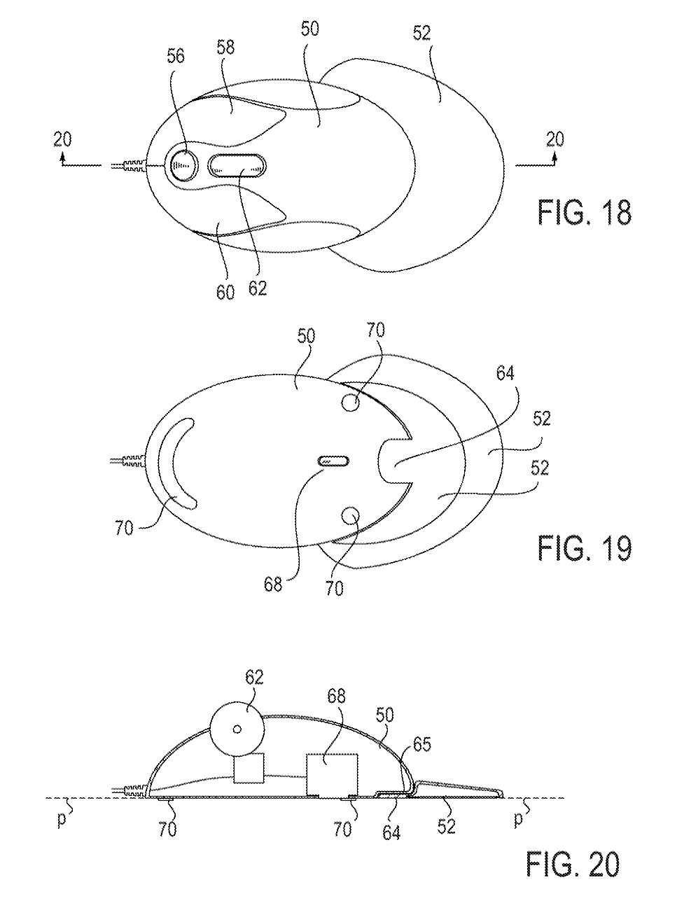

FIG. 18 is a top plan view of the mouse assembly 48 of FIG. 16. Depicted in the figure are the mouse's (a) top button 56 (for additional dimensional input), (b) left top button 60, (c) right top button 58, and (d) scroll wheel 62. Not shown in this figure are the right button 54 and the left button, both of which provide additional dimensional input they are hidden in recesses in the sides of the mouse 50.

FIG. 19 is a bottom plan view of the mouse assembly 48 of FIG. 16. This figure illustrates an opto-electric sensor 68 on the bottom surface of the mouse 50 and three mouse feet, each of which is labeled 70.

FIG. 20 is a cross-sectional view taken along line 20-20 of FIG. 18. For ease of comprehension, the figure illustrates the scroll wheel 62 depicted in FIG. 18, as well as the opto-electric sensor 68. Also illustrated in FIG. 20 are two mouse feet 70. The figure further illustrates how the mouse 50 and the stabilizer 52 are coplanar along a plane p-p when the stabilizer 52 is attached to the mouse 50. This is due to the tab support 64 engaging a corresponding slot 65 in the bottom surface of the mouse 50. The tab 66 engages a tang 67 provided in a slot (not seen) to lock the stabilizer 52 to the mouse 50 as previously described.

In an alternative exemplary embodiment, the mouse and stabilizer are formed together such that they comprise a unitary body. Such a mouse assembly would not have a detachable stabilizers, but would be less prone to loss of stability resulting from wear and tear to locking parts.

While a number of exemplary embodiments have been discussed above, those of skill in the art will recognize certain modifications, permutations, additions and sub-combinations thereof. For example, the above stabilizer might be used with any mouse with extra or additional buttons, regardless of whether those buttons provide dimensional input or input related to image manipulation. It is therefore intended that claims hereafter introduced are interpreted to include all such modifications, permutations, additions, and sub-combinations as are within their true spirit and scope.

1. A multidimensional mouse comprising:
a mouse body having a substantially planar bottom surface and a curved upper surface including a top surface portion generally opposing said bottom surface, a left surface portion, a right surface portion, a front surface portion, and an opposing back surface portion;
an x-y sensor carried by said body and associated said bottom surface;
a top button associated with said top surface portion;
a left button associated with said left surface portion;
a right button associated with said right surface portion; and
a stabilizer extending rearwardly from said back surface portion and having a substantially planar bottom surface which is substantially coplanar with said bottom surface and said mouse body.

2. A multidimensional mouse as in claim 1, wherein said stabilizer extends along at least one of said right surface portion and said left surface portion towards said right button and said left button respectively.

3. A multidimensional mouse as in claim 1, wherein said stabilizer forms a part of said body.

4. A multidimensional mouse as in claim 1, wherein said stabilizer is attached to said body.

5. A multidimensional mouse as in claim 4, wherein said stabilizer is removably attached to said body.

6. A multidimensional mouse as in claim 5, wherein said stabilizer is removably attached to said body by one or more tabs on said stabilizer that lock into one or more corresponding slots on said bottom surface of said mouse.

7. A multidimensional mouse as in claim 6, wherein said one or more tabs are supported by one or more tab supports of said stabilizer.

8. A multidimensional mouse as in claim 7, wherein said bottom surface is provided with one or more recesses receptive to said one or more tab supports, whereby said one or more corresponding slots are located within said one or more recesses.

9. A multidimensional mouse as in claim 2, wherein said stabilizer includes an opening aligned with said x-y sensor.

10. A multidimensional mouse as in claim 8, wherein said x-y comprises an opto-electric sensor to detect movement of said mouse relative to a supporting surface.

11. A multidimensional mouse as in claim 8, wherein said x-y sensor comprises a LED.

12. A multidimensional mouse as in claim 1, wherein said x-y sensor comprises a track-ball.

13. A mouse stabilizer comprising:
a U-shaped body having a substantially planar bottom surface and a curved upper surface, said body having a heel rest portion and a pair of leg portions defining an opening; and
a tab support extending into said opening and having a bottom surface substantially coplanar with said bottom surface of said body and a top surface recessed from said top surface of said body, said tab support being provided with a tab extending upward from said upper surface.

14. A mouse stabilizer as in claim 13, wherein one of said pair of leg portions is elongated to provide a finger-rest.

15. A mouse stabilizer as in claim 13, wherein another of said pair of leg portions is elongated to provide a thumb-rest.

16. A mouse stabilizer as in claim 13, wherein said tab support extends between said pair of leg portions.

17. A mouse stabilizer as in claim 13, wherein said portion-shaped body, tab support, and tab are of a unitary structure.

18. A mouse stabilizer as in claim 13, wherein said tab support is removably attached to said U-shaped body.

19. A mouse stabilizer as in claim 13, further comprising a plurality of stabilizer supports, at least one of which is said tab support, which extends into said opening.

20. A multidimensional mouse comprising:
a mouse body having a substantially planar lower surface means provided with recesses; and
a stabilizer means having a substantially planar lower surface which is substantially coplanar with said lower surface means when said stabilizer means is engaged with said mouse body and which engages said recesses of said mouse body.
